(19) United States
(12) Patent Application Publication
(10) Pub. No.: US 2026/0140592 A1
(43) Pub. Date: May 21, 2026

(54) INPUT DEVICE, NON-CONTACT OPERATION UNIT, AND IMAGE FORMING APPARATUS

(71) Applicant: Reo KOJIMA, Kanagawa (JP)

(72) Inventor: Reo KOJIMA, Kanagawa (JP)

(21) Appl. No.: 19/337,968

(22) Filed: Sep. 24, 2025

(30) Foreign Application Priority Data
Nov. 21, 2024 (JP) 2024-203139

(51) Int. Cl. G06F 3/042; G06F 3/041; H04N 1/00

(52) U.S. Cl. CPC G06F 3/0421; G06F 3/04186; H04N 1/00411; H04N 1/00496; G06F 2203/04107; G06F 2203/04108

(57) ABSTRACT

An input device includes a display having a display surface on which an operation screen is displayed; and a non-contact detector. The non-contact detector includes a light emitter to emit light in a first direction to form a detection plane above the display surface to detect an object; and a light receiver to receive reflection light, emitted from the light emitter and reflected from the object on the detection plane, to detect a position of the object on the detection plane. The detection plane has a first distance between a first end of the display surface in the first direction and a first position on the detection plane. The detection plane also has a second distance between a second end, opposite to the first end, of the display surface in the first direction and a second position on the detection plane. The first distance is shorter than the second distance.

### CROSS-REFERENCE TO RELATED APPLICATIONS

This patent application is based on and claims priority pursuant to 35 U.S.C. § 119(a) to Japanese Patent Application No. 2024-203139, filed on Nov. 21, 2024, in the Japan Patent Office, the entire disclosure of which is hereby incorporated by reference herein.

### BACKGROUND

### Technical Field

The present disclosure relates to an input device, a non-contact operation unit, and an image forming apparatus.

### Related Art

A typical input device includes a display unit that displays an operation screen, and a non-contact operation detection unit that detects a non-contact operation performed by an operator with respect to the operation screen.

### SUMMARY

According to an embodiment of the present disclosure, an input device includes a display having a display surface on which an operation screen is displayed; and a non-contact detector. The non-contact detector includes a light emitter to emit light in a first direction to form a detection plane above the display surface to detect an object; and a light receiver to receive reflection light, emitted from the light emitter and reflected from the object on the detection plane, to detect a position of the object on the detection plane. The detection plane is inclined with respect to the display surface. The detection plane has a first distance between a first end of the display surface in the first direction and a first position on the detection plane, the first position at a position where a perpendicular line perpendicular to the display surface and extending from the first end intersects the detection plane at the first position. The detection plane also has a second distance between a second end, opposite to the first end, of the display surface in the first direction and a second position on the detection plane, the second position at a position where a perpendicular line perpendicular to the display surface and extending from the second end intersects the detection plane at the second position. The first distance is shorter than the second distance.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an image forming apparatus according to an embodiment of the present disclosure;

FIG. 2 is a perspective view of an operation panel according to the embodiment of the present disclosure;

FIG. 3 is a perspective view of a detection plane of a non-contact operation sensor according to the embodiment of the present disclosure;

FIG. 4 is a functional block diagram of the operation panel illustrated in FIG. 2;

FIGS. 5A and 5B are diagrams illustrating an example of an operation performed by a short user above the operation panel when the detection plane is parallel to a display surface of a display unit;

FIG. 6 is a diagram illustrating the detection plane of the non-contact operation sensor according to the embodiment of the present disclosure;

FIGS. 7A and 7B are diagrams illustrating an example of an operation performed by a short user above the operation panel when the detection plane is inclined with respect to the display surface of the display unit;

FIG. 8 is a schematic diagram illustrating an operation panel according to a first modification of the embodiment of the present disclosure;

FIG. 9 is a schematic diagram illustrating an operation panel according to a second modification of the embodiment of the present disclosure;

FIG. 10 is a diagram illustrating a raised position and a flat position of the operation panel according to the embodiment of the present disclosure; and

FIGS. 11A and 11B are diagrams illustrating parallax between the detection plane and the display surface.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

For example, the input device is included in an image forming apparatus.

A non-contact operation unit serving as the non-contact operation detection unit includes a non-contact sensor. The non-contact sensor detects a non-contact operation by detecting the position of the pointer, such as a finger of an operating person, entering a detection plane, which is a spatial area a predetermined distance above a display surface of the display unit on which the operation screen is displayed, thereby detecting the non-contact operation. For example, the detection plane is parallel to the display surface.

However, a non-contact operation performed by a short user may be erroneously detected.

According to one embodiment of the present disclosure, a non-contact operation performed by a short user may be correctly detected.

An input device used as an operation panel of an image forming apparatus according to an embodiment of the present disclosure will be described hereinafter.

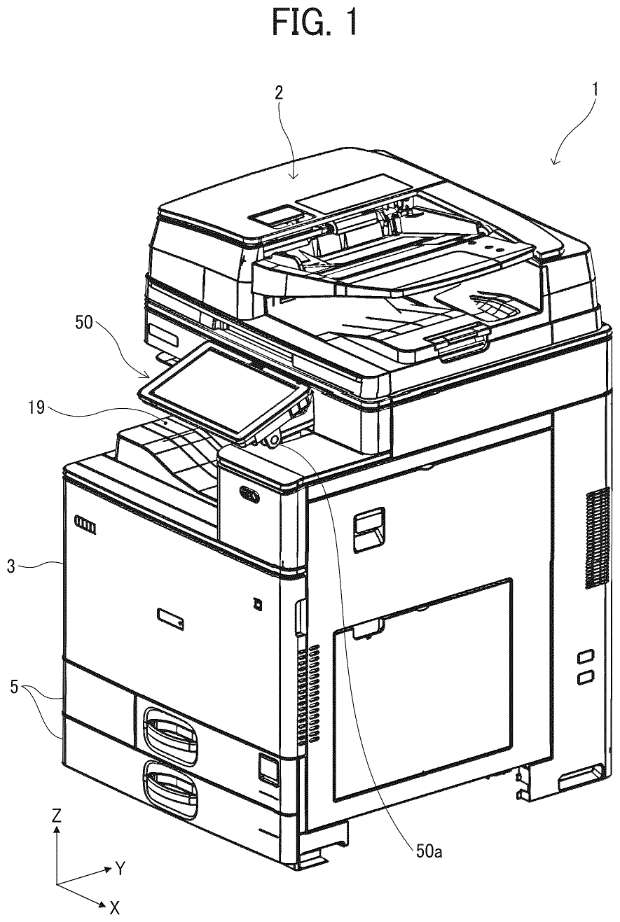

FIG. 1 is a perspective view of an image forming apparatus 1 according to the present embodiment.

The image forming apparatus 1 is a copying machine including an image reading device 2 disposed in an upper portion of a main body 3 of the image forming apparatus 1 (hereinafter referred to as the “image forming apparatus main body 3”). The image forming apparatus main body 3 includes a recording paper storage unit 5 that stores recording paper serving as recording media on which images are to be formed, and an image forming unit (image formation unit) serving as an image forming means.

An operation panel 50 is provided on a front surface of the image forming apparatus 1. The front surface of the image forming apparatus 1 is defined as the surface that faces a user during normal operation. The operation panel 50 is an input device used by the user to perform various input operations related to an image forming operation or used to display information related to the image forming operation. The operation panel 50 is rotatably supported by a support shaft 50a, and can be inclined at varying angles.

The image forming unit includes, for example, an exposure unit serving as an exposure means, multiple photoconductor drums, a developing device using toners of four colors, namely, cyan (C), magenta (M), yellow (Y), and black (K), a transfer belt serving as an intermediate transfer member, a secondary transfer unit, and a fixing unit. For example, the image forming unit forms an image in the following way based on a read image of a document read by the image reading device 2 or print data transmitted from an external device such as a personal computer (PC). In the image forming unit, the exposure unit exposes the photoconductor drums of the respective colors to light to form electrostatic latent images on the photoconductor drums, based on the print data, and developing units of the respective colors in the developing device supply toner onto the latent images on the photoconductor drums to develop the latent images to form toner images. In the image forming unit, furthermore, the toner images on the photoconductor drums of the respective colors are primarily transferred onto the transfer belt, and the secondary transfer unit secondarily transfers the toner images onto recording paper serving as a recording medium in a superimposed manner. After that, the fixing unit applies heat and pressure to the resulting toner image on the recording paper to fix the toner image. As a result, the image forming unit can form a color image. The recording paper on which the image has been formed is discharged to a paper output tray 19 on an upper surface of the image forming apparatus main body 3.

There has recently been an increasing demand for non-contact operation of a touch panel or buttons, which are touched by an unspecified number of users, in order to avoid contact with pathogens such as viruses or bacteria that cause infectious diseases. The operation panel 50 of the image forming apparatus 1 of a floor-mounted type, such as the image forming apparatus 1 illustrated in FIG. 1, may also be operated by an unspecified number of users, and some users do not wish direct contact with the operation panel 50.

To meet such users'demand, the operation panel 50 according to the present embodiment is provided with a non-contact sensor so as to allow users to operate the operation screen without touching the operation screen.

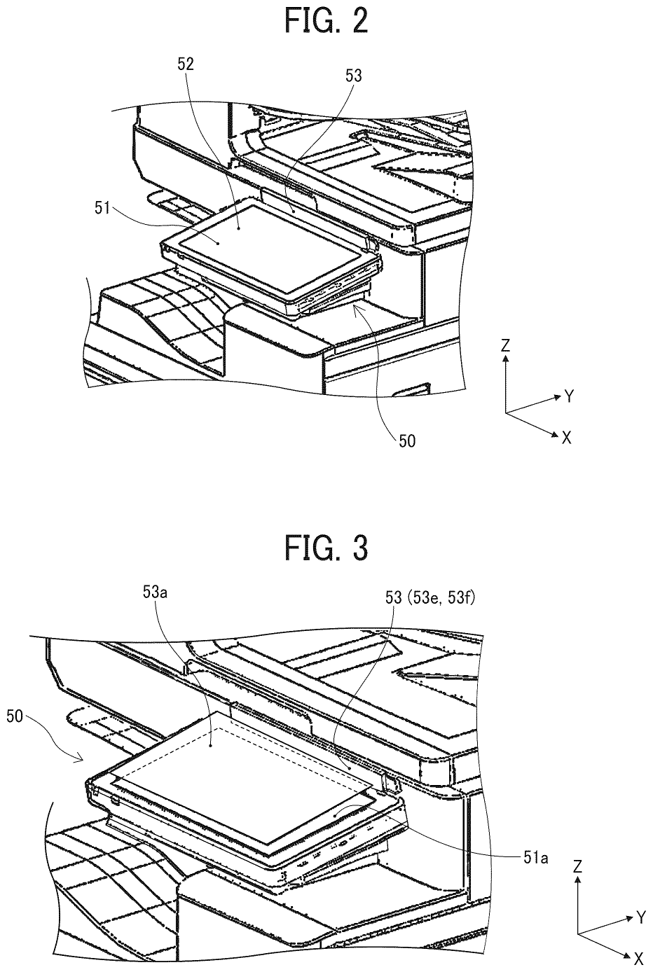

FIG. 2 is a perspective view of the operation panel 50.

As illustrated in FIG. 2, the operation panel 50 includes a display unit 51 (or a display) such as a liquid crystal display (LCD) or a cathode-ray tube (CRT) display, a touch panel 52 serving as a contact detector, and a non-contact sensor 53 serving as a non-contact detector.

The touch panel 52 is a capacitive or pressure-sensitive contact sensor, and is provided so as to overlap the display unit 51. The touch panel 52 has a sensing surface that senses contact. In response to a user's finger coming into contact with the sensing surface, the touch panel 52 detects the contact position.

The non-contact sensor 53 serves as a non-contact operation unit configured to be attachable to and detachable from the operation panel 50, and is optionally attached to the rear side of the operation panel 50, which faces away from the operating user. The non-contact sensor 53 is coupled to a connection terminal such as a universal serial bus (USB) terminal provided on the bottom of the operation panel 50, thereby communicating with, for example, a panel control unit 60 (described below) that controls the operation panel 50 and being supplied with power.

The non-contact sensor 53 includes an array of optical units each including a light-emitting element 53e (or a light emitter) that emits infrared light and a light-receiving element 53f (or a light receiver) that receives infrared light. As illustrated in FIG. 3, a spatial region that is a predetermined distance above the operation screen of the display unit 51 defines a detection plane 53a for detecting a non-contact operation performed by a user above the operation screen. When the user's finger enters the detection plane 53a, diffusely reflected infrared light reflected from the finger, which results from the infrared light emitted from the light-emitting elements 53e, is received by the light-receiving elements 53f, and the position of the tip of the finger is detected based on the amounts of infrared light received by the light-receiving elements 53f.

An input device includes a display (e.g., the display unit 51) having a display surface 51a on which an operation screen is displayed; and a non-contact detector (e.g., the non-contact sensor 53). The non-contact detector includes a light emitter 53e to emit light in a first direction to form a detection plane 53a above the display surface to detect an object; and a light receiver 53f to receive reflection light, emitted from the light emitter and reflected from the object on the detection plane, to detect a position of the object on the detection plane 53a.

The input device (e.g., the operation panel 50) further includes circuitry (e.g., the panel control unit 60) receives the position of the object from the non-contact detector (e.g., the non-contact sensor 53); and detects a non-contact operation performed by the object without contacting the display surface. The light emitter emits infrared light having a scanning optical path in the first direction.

A non-contact sensor of the related art is a dual-axis scanning optical path sensor that defines a scanning optical path of infrared light emitted in the vertical direction of a display unit and a scanning optical path of infrared light emitted in the horizontal direction of the display unit. The non-contact sensor of the related art includes light-emitting elements arranged in an array on one of opposing sides thereof with the display unit interposed therebetween and light-receiving elements arranged in an array on the other opposing side. The light emitted from the light-emitting elements is blocked by a fingertip entering a detection plane and therefore does not reach some of the light-receiving elements. The non-contact sensor of the related art detects the position of the fingertip based on the positions of the light-receiving elements that fail to receive the light. Accordingly, the non-contact sensor of the related art has a frame body surrounding the display unit, and the frame body may make it difficult for a user to operate an edge of the operation screen, resulting in operability issues. Another issue is the impairment of appearance.

In contrast, the non-contact sensor 53 according to the present embodiment is a single-axis scanning optical path sensor that defines a single scanning optical path of infrared light emitted in the vertical direction of the display unit 51 from the rear side of the operation panel 50 (i.e., in the front-rear direction of the image forming apparatus 1, or the Y direction in FIG. 3). The infrared light diffusely reflected from the user's finger entering the detection plane 53a toward the rear side of the operation panel 50 is received by the light-receiving elements to detect the position of the tip of the finger. Accordingly, the non-contact sensor 53 according to the present embodiment is disposed only on the rear side of the operation panel 50, resulting in improved operability at an edge of the operation screen compared to the non-contact sensor of the related art configured to surround the display unit. In addition, the appearance is not impaired.

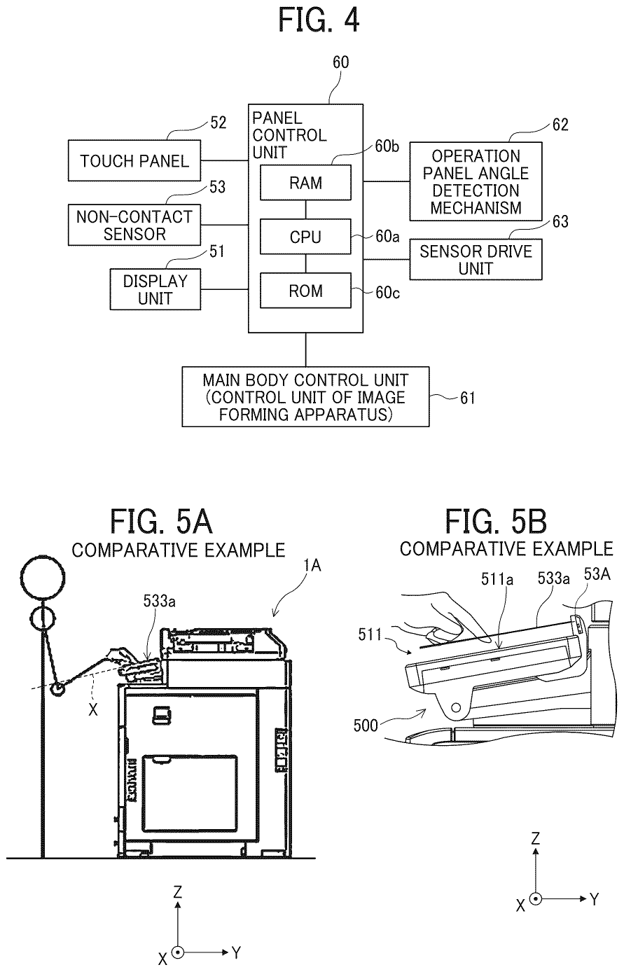

FIG. 4 is a functional block diagram of the operation panel 50. An operation panel angle detection mechanism 62 and a sensor drive unit 63 illustrated in FIG. 4 are included in an operation panel 50B according to a second modification described below.

As illustrated in FIG. 4, the operation panel 50 includes a panel control unit 60, which is implemented by a computer device such as a microcomputer. The panel control unit 60 includes a central processing unit (CPU) 60a. The panel control unit 60 further includes a read only memory (ROM) 60c and a random access memory (RAM) 60b serving as storage means coupled to the CPU 60a through a bus line. The CPU 60a executes a control program, which is a computer program installed in advance, to control the display unit 51 or detect an operation by the user, based on position information detected by the non-contact sensor 53 or the touch panel 52 and an operation screen displayed on the display unit 51. The ROM 60c stores in advance computer programs and fixed data such as control data. The RAM 60b functions as a work area or the like that stores various data in a rewritable manner.

As described above, in response to the user's finger coming into contact with the sensing surface for sensing contact, the touch panel 52 detects the contact position. Position information indicating the position detected by the touch panel 52 is transmitted to the panel control unit 60. Then, the panel control unit 60 detects a contact operation performed on the operation screen displayed on the display unit 51, based on the position information indicating the position detected by the touch panel 52.

The input device (e.g., the operation panel 50) further includes a contact detector (e.g., the touch panel 52) to detect a position of the object performing a contact operation on the operation screen.

As described above, the non-contact sensor 53 receives, with the multiple light-receiving elements, diffusely reflected infrared light reflected from the user's finger entering the detection plane 53a, which results from the infrared light emitted from the light-emitting elements 53e, and detects the position of the tip of the finger based on the amounts of infrared light received by the light-receiving elements 53f. Position information indicating the position detected by the non-contact sensor 53 is transmitted to the panel control unit 60. Then, the panel control unit 60 detects a non-contact operation performed above the operation screen displayed on the display unit 51, based on the position information indicating the position detected by the non-contact sensor 53.

The panel control unit 60 identifies information related to an image forming operation input through the operation by the user, based on the detected operation performed by the user with respect to the operation screen, and transmits the identified information related to the image forming operation to a main body control unit 61 (a control unit of the image forming apparatus 1).

The floor-mounted image forming apparatus 1 illustrated in FIG. 1 is configured such that the paper output tray 19 and the image reading device 2 are positioned at a height around the waist of most users operating the image forming apparatus 1 so that such users can easily work on the image forming apparatus 1. With this configuration, when operating the operation panel 50, most users look down at the operation panel 50, which is located at substantially the same height as the image reading device 2. Since most users look down at the operation panel 50 when operating the operation panel 50, the operation panel 50 is set in a flat position (at an angle of about 10 degrees to 20 degrees with respect to the horizontal) so that most users can easily view the operation screen displayed on the display unit 51 of the operation panel 50. The operation panel 50 set in the flat position prevents a portion of the operation panel 50 from being above the scanning surface of the image reading device 2, and prevents the operation panel 50 from interfering with the user setting a document on the scanning surface.

In the related art, the detection plane 533a of the non-contact sensor 53A (i.e., the direction in which the light-emitting elements 53e emit infrared light) is parallel to a display surface 511a of the display unit 511. The operation panel 500 is positioned at a height around the waist of most users, and accordingly most users' elbows are positioned above a forward extension X (see FIG. 5A) of the detection plane 533a of the non-contact sensor 53A toward the users. When the operating user's elbow is positioned above the forward extension X of the detection plane 533a of the non-contact sensor 53A, a pointer or an object, such as a finger of the user, enters the detection plane 533a while staying perpendicular to (or at a large angle of approach to) the detection plane 533a.

This allows the non-contact sensor 53 to reliably detect the position pointed at by the finger on the operation screen, and allows reliable detection of a non-contact operation performed by the user.

FIGS. 5A and 5B are diagrams illustrating an example of an operation performed by a short user above the operation panel 500 when the detection plane 533a is parallel to the display surface 511a of the display unit 51. FIG. 5A is an overall view of the image forming apparatus 1A, and FIG. 5B is an enlarged view of the operation panel 500 and a peripheral portion thereof.

As illustrated in FIG. 5A, when a short user operates the image forming apparatus 1A while standing in front of the image forming apparatus 1A, the elbow of the user may be positioned below the forward extension X of the detection plane 533a of the non-contact sensor 53. As a result, as illustrated in FIG. 5B, the finger (i.e., pointer) used for operation enters the detection plane 533a while staying non-perpendicular to (or at a small angle of approach to) the detection plane 533a. The user raises the elbow, thereby allowing the finger used for operation to enter the detection plane 533a while staying perpendicular to (or at a large angle of approach to) the detection plane 533a. However, it is highly unlikely that the user operates the operation panel 500 in front of the user while raising the elbow. The reason for this is that using force to raise the elbow and holding the elbow in position is inefficient.

Thus, when a short user operates the image forming apparatus 1A while standing in front of the image forming apparatus 1A, in most cases, the finger used for operation enters the detection plane 533a while staying non-perpendicular to (or at a small angle of approach to) the detection plane 533a, as illustrated in FIG. 5B. In such cases, a hand portion other than the finger used for operation, such as the fist facing inward, may also enter the detection plane 533a, resulting in erroneous detection of the non-contact operation performed by the user.

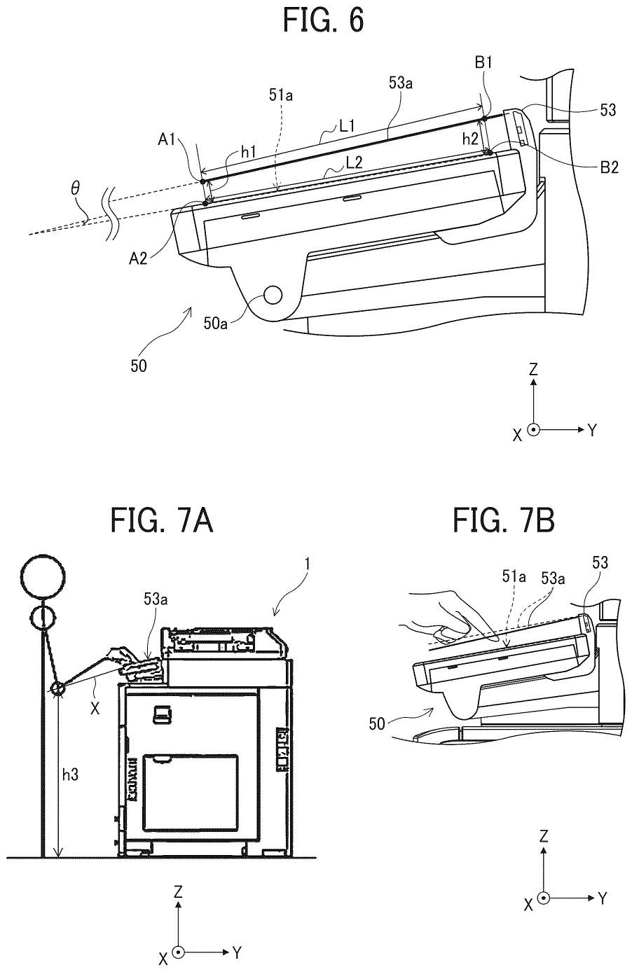

In the present embodiment, accordingly, as illustrated in FIG. 6, the detection plane 53a is inclined with respect to the display surface 51a such that a distance h1 from a user-facing-side edge A2 of the display surface 51a of the display unit 51 to the detection plane 53a (e.g., a position A1 at which a perpendicular line from the user-facing-side edge A2 intersects the detection plane 53a) is shorter than a distance h2 from a rear-side edge B2 of the display surface 51a of the display unit 51 to the detection plane 53a (e.g., a position B1 at which a perpendicular line from the rear-side edge B2 intersects the detection plane 53a).

In other words, the detection plane is inclined with respect to the display surface. The detection plane has a first distance h1 between a first end (e.g., the user-facing-side edge A2) of the display surface 51a in the first direction (e.g., in the front-rear direction of the image forming apparatus 1) and a first position (e.g., the position A1) on the detection plane, the first position at a position where a perpendicular line perpendicular to the display surface and extending from the first end intersects the detection plane 53a at the first position. The detection plane also has a second distance h2 between a second end (e.g., the rear-side edge B2), opposite to the first end, of the display surface 51a in the first direction and a second position (e.g., the position B1) on the detection plane, the second position at a position where a perpendicular line perpendicular to the display surface and extending from the second end B2 intersects the detection plane 53a at the second position. The first distance h1 is shorter than the second distance h2.

The distance between the detection plane 53a and the display surface 51a of the display unit 51 is preferably about 10 mm to 15 mm.

If the distance between the detection plane 53a and the display surface 51a is less than 10 mm, the tip of the finger is more likely to come into contact with the touch panel 52, and thus the non-contact operation may fail to be performed. On the other hand, if the distance between the detection plane 53a and the display surface 51a is greater than or equal to 15 mm, a displacement (i.e., parallax) at the position of the operation screen on the detection plane 53a, caused by the angle at which the operation screen is viewed, increases. As a result, the displacement at the position pointed at by the finger increases depending on the angle at which the user views the operation screen displayed on the display unit 51, and the non-contact operation may fail depending on the user. Accordingly, an inclination angle θ of the detection plane 53a is preferably set such that the distance h1 from the user-facing-side edge A2 of the display surface 51a to the detection plane 53a is approximately 10 mm and the distance h2 from the rear-side edge B2 of the display surface 51a to the detection plane 53a is approximately 15 mm.

Setting the distance h1 from the user-facing-side edge A2 of the display surface 51a to the detection plane 53a to approximately 10 mm and the distance h2 from the rear-side edge B2 of the display surface 51a to the detection plane 53a to approximately 15 mm achieves the following effects. One of the effects is that the user can operate a portion of the operation screen displayed on the display unit 51 closer to the user without touching the touch panel 52 with the fingertip.

Another effect is that failures caused when the user operates a portion of the operation screen farther from the user, such as a failure to detect the operation of pointing at a predetermined position on the operation screen depending on the angle at which the operation screen is viewed, can be prevented or mitigated. In addition, the difference between the distance h1 from the user-facing-side edge A2 of the display surface 51a to the detection plane 53a and the distance h2 from the rear-side edge B2 of the display surface 51a to the detection plane 53a can be set to be less than or equal to 5 mm.

As a result, it is possible to reduce the discomfort felt by the user due to the difference in distance from the display surface 51a between the non-contact operation of a portion of the operation screen displayed on the display unit 51 farther from the user and the non-contact operation of a portion of the operation screen closer to the user.

It is generally recommended that the allowable displacement between the detection position on the touch panel 52 and the operation screen be within ±0.5 mm. A greater displacement may cause an operational failure such as a failure to respond to pressing of a predetermined position on the operation screen. Accordingly, as illustrated in FIG. 6, it is preferable to set the inclination angle θ of the detection plane 53a with respect to the display surface 51a such that the difference between a dimension L2 of the display unit 51 (the display surface 51a) in the front-rear direction and a dimension L1 of the detection plane 53a in the front-rear direction falls within 0.5 mm. With this configuration, the difference between the position of the fingertip entering the detection plane 53a in the front-rear direction, which is detected by the non-contact sensor 53, and the position of the operation screen in the front-rear direction can be kept within 0.5 mm. As a result, a non-contact operation can be detected with accuracy equivalent to that for the touch panel 52, and the user can perform the non-contact operation in a natural manner. A rear-side edge of the detection plane 53a is defined as an intersection between a perpendicular line of the display surface 51a, which extends from the rear-side edge B2 of the display surface 51a, and the detection plane 53a (i.e., the scanning optical path of infrared light from the light-emitting elements 53e). A user-facing-side edge of the detection plane 53a is defined as an intersection between a perpendicular line of the display surface 51a, which extends from the user-facing-side edge A2 of the display surface 51a, and the detection plane 53a (i.e., the scanning optical path of infrared light from the light-emitting elements 53e). In the present embodiment, when the inclination angle θ is 5 degrees, the difference between the dimensions L1 and L2 (i.e., L1−L2) is approximately 0.5 mm. Thus, setting the inclination angle θ to be less than or equal to 5 degrees can make the difference between the dimensions L1 and L2 (i.e., L1−L2) fall within 0.5 mm. The user can perform the non-contact operation in a natural manner.

A difference between a first dimension (e.g., the dimension L1) and a second dimension (e.g., the dimension L2) is less than or equal to 0.5 mm. The first dimension is a dimension of the detection plane 53a from the first position (e.g., the position A1) to the second position (e.g., the position B1). The second dimension is a dimension of the display surface from the first end (e.g., the user-facing-side edge A2 of the display surface 51a) to the second end (e.g., the rear-side edge B2 of the display surface 51a).

FIGS. 7A and 7B are diagrams illustrating an example of an operation performed by a short user above the operation panel 50 when the detection plane 53a is inclined with respect to the display surface 51a of the display unit 51. FIG. 7A is an overall view of the image forming apparatus 1, and FIG. 7B is an enlarged view of the operation panel 50 and a peripheral portion thereof. In FIG. 7B, a broken line indicates the detection plane 53a parallel to the display surface 51a.

As illustrated in FIG. 7A, in the present embodiment in which the detection plane 53a of the non-contact sensor 53 is inclined with respect to the display surface 51a, when a short user operates the image forming apparatus 1 while standing in front of the image forming apparatus 1, the elbow of the user may be positioned above the forward extension X of the detection plane 53a of the non-contact sensor 53. As a result, as illustrated in FIG. 7B, the finger used for operation enters the detection plane 53a while staying perpendicular to (or at a large angle of approach to) the detection plane 53a, compared to the case where, as indicated by the broken line, the detection plane 53a is parallel to the display surface 51a. Thus, a hand portion other than the finger used for operation, such as the fist facing inward, can be prevented from entering the detection plane 53a, and erroneous detection of the non-contact operation performed by the user is less likely to occur.

In the present embodiment, the inclination angle θ of the detection plane 53a with respect to the display surface 51a is set so that, when the user stands in front of the image forming apparatus 1, a height h3 of a point on the forward extension X of the detection plane 53a at the position of the elbow of the user in the front-rear direction (i.e., the Y direction in FIG. 7A) is equal to the elbow height of the 5th-percentile Japanese female as specified in the anthropometric chart. This configuration allows most users to perform non-contact operations reliably.

In the present embodiment, the inclination angle θ is set to 3 degrees. This can make the height h3 equal to the elbow height of the 5th-percentile Japanese female as specified in the anthropometric chart. The display surface 51a of the display unit 51 according to the present embodiment has a vertical dimension (i.e., dimension in the front-rear direction) of approximately 125 mm. Thus, the distance from the center of the display surface 51a in the front-rear direction to the detection plane 53a is set to approximately 13 mm. In this case, the distance h1 from the user-facing-side edge A2 of the display surface 51a to the detection plane 53a is 9.7 mm, and the distance h2 from the rear-side edge B2 of the display surface 51a to the detection plane 53a is 16.3 mm. With this configuration, the distance between the detection plane 53a and the display surface 51a can be set in a range close to the preferred range of 10 mm to 15 mm described above.

The detection plane 53a has an inclination angle of three degrees to five degrees with respect to the display surface 51a.

Each of the first distance (e.g., the distance h1) and the second distance (e.g., the distance h2) is greater than or equal to 10 mm; and less than or equal to 15 mm.

Modifications of the present embodiment will now be described.

### First Modification

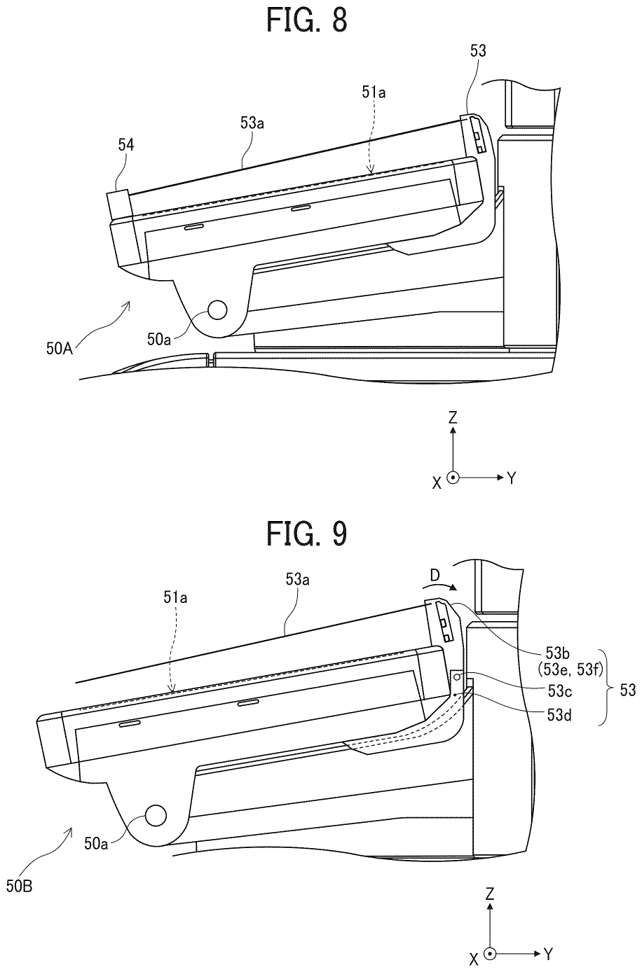

FIG. 8 is a schematic diagram illustrating an operation panel 50A according to a first modification.

In the first modification, the operation panel 50A includes a light blocking member 54 (or a light shield) at a user-facing-side edge thereof.

As described above, the non-contact sensor 53 according to the present embodiment receives, with the multiple light-receiving elements, diffusely reflected infrared light from the finger (i.e., pointer) entering the detection plane 53a for operation and detects the position of the finger based on the amounts of infrared light received by the light-receiving elements. This configuration may cause erroneous detection when a highly reflective object having a high reflectance (e.g., a plastic card such as an employee ID card) is present in front of the operation panel 50, because the light-receiving elements receive infrared light reflected from the highly reflective object.

As presented in the first modification, the light blocking member 54 is provided at the user-facing-side edge of the operation panel 50A. Accordingly, even when a highly reflective object is present in front of the operation panel 50A, the highly reflective object can be prevented from being irradiated with infrared light emitted from the light-emitting elements 53e. With this configuration, erroneous detection by the non-contact sensor 53 is less likely to occur.

The input device (e.g., the operation panel 50A) further includes a light shield (e.g., the light blocking member 54), at a third end downstream from the first end (e.g., the user-facing-side edge A2 of the display surface 51a) in the first direction (e.g., the front-rear direction of the image forming apparatus 1), to block the infrared light.

In addition, the detection plane 53a is inclined with respect to the display surface 51a such that the distance from the display surface 51a to the detection plane 53a is smaller on the user-facing side than on the rear side facing away from the operating user. Thus, the infrared light emitted from the non-contact sensor 53 can be reliably blocked even when the height of the light blocking member 54 is low. Accordingly, the light blocking member 54 can be prevented from interfering with operation by the user, and allow the user to operate without impairment of operability.

### Second Modification

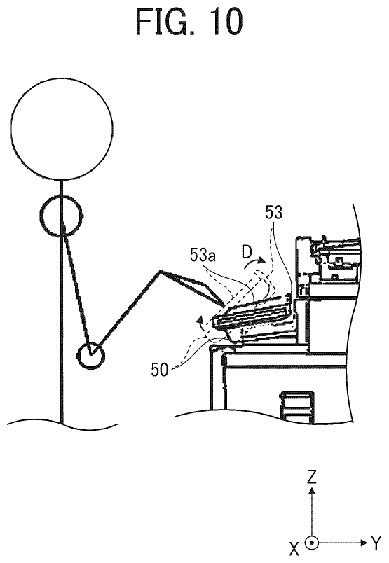

FIG. 9 is a schematic diagram illustrating an operation panel 50B according to a second modification.

In the second modification, the inclination angle θ of the detection plane 53a is adjustable.

In other words, the detection plane 53a has an adjustable inclination angle with respect to the display surface 51a.

As illustrated in FIG. 9, in the second modification, the non-contact sensor 53 includes a sensor unit 53b and an attachment unit 53d. The sensor unit 53b includes a light-emitting element 53e and a light-receiving element 53f. The attachment unit 53d is attachable to the operation panel 50B. The sensor unit 53b includes a rotation shaft 53c, and the rotation shaft 53c is rotatably supported by the attachment unit 53d.

The operation panel 50B is rotatably supported by the support shaft 50a. For example, the operation screen displayed on the display unit 51 may be difficult to view due to reflection of sunlight or the like. In this case, in FIG. 10, the operation panel 50B is rotated in a manner as indicated by a broken line to raise the operation panel 50B (e.g., change the inclination of the operation panel 50B so that the operation panel 50B can be inclined at an angle of 45 degrees with respect to the horizontal). In the second modification, when the operation panel 50B is raised (i.e., when the operation panel 50B is inclined at an angle of 45 degrees with respect to the horizontal), the sensor unit 53b is rotated in a direction indicated by an arrow D in FIGS. 9 and 10 to set the detection plane 53a to be parallel to the display surface 51a (i.e., set the inclination angle θ to be equal to 0 degrees).

Specifically, the operation panel angle detection mechanism 62 (see FIG. 4) and the sensor drive unit 63 (see FIG. 4) are provided. The operation panel angle detection mechanism 62 serves as an angle detector to detect the angle of the operation panel 50B with respect to the horizontal. The sensor drive unit 63 serves as an adjuster to rotationally drive the sensor unit 53b of the non-contact sensor 53. The operation panel angle detection mechanism 62 includes a filler and an optical sensor. For example, when the operation panel 50B is raised (e.g., the angle of the operation panel 50B with respect to the horizontal is changed to 45 degrees), the filler blocks light traveling from a light-emitting element 53e of the optical sensor toward a light-receiving element 53f of the optical sensor. Thus, the change of the operation panel 50B from the flat position to the raised position (e.g., the change in the angle of the operation panel 50B with respect to the horizontal to 45 degrees) can be detected. In another example, an encoder sensor may be used to detect the angle of the operation panel 50B with respect to the horizontal.

The panel control unit 60 (see FIG. 4) drives the sensor drive unit 63 to change the inclination angle θ of the detection plane 53a with respect to the display surface 51a, based on the angle of the operation panel 50B detected by the operation panel angle detection mechanism 62.

The input device (e.g., the operation panel 50B) further includes an angle detector (e.g., the operation panel angle detection mechanism 62) to detect a changeable angle of the display surface 51a with respect to a horizontal direction of the display surface 51a; and an adjuster (e.g., the sensor drive unit 63) to adjust the adjustable inclination angle of the detection plane 53a with respect to the display surface 51a, based on a detection result of the angle detector.

When the operation panel 50B is raised, a finger of even a short user, which is used for operation, enters the detection plane 53a while staying perpendicular to (or at a large angle of approach to) the detection plane 53a.

Thus, when the operation panel 50B is in the raised position, erroneous detection of a non-contact operation does not occur even if the detection plane 53a is set to be parallel to the display surface 51a (i.e., the inclination angle θ is set to be equal to 0 degrees). As the inclination angle θ of the detection plane 53a with respect to the display surface 51a decreases, the difference between the distance from the display surface 51a to the detection plane 53a on the user-facing side and the distance from the display surface 51a to the detection plane 53a on the rear side facing away from the user decreases. This removes the discomfort caused by the difference in distance from the display surface 51a between when the user performs a non-contact operation on the user-facing side and when the user performs a non-contact operation on the rear side.

Accordingly, when the operation panel 50B is raised (or inclined at an angle of 45 degrees with respect to the horizontal), the detection plane 53a is set to be parallel to the display surface 51a (i.e., the inclination angle θ is set to be equal to 0 degrees), thus allowing the user to perform the non-contact operation in a more natural manner.

In another example, a camera or the like may be used to detect the height or elbow position of the user standing in front of the operation panel 50, and the inclination angle θ of the detection plane 53a with respect to the display surface 51a may be changed based on the detected height or elbow position. For example, when the height or elbow position of the user standing in front of the operation panel 50 is greater than or equal to a predetermined height, the detection plane 53a is set to be parallel to the display surface 51a (i.e., the inclination angle θ is set to be equal to 0 degrees). In another example, when the operation panel 50 is raised (or inclined at an angle of 45 degrees with respect to the horizontal), a camera may be used to determine whether the user is a wheelchair user, and no change may be made to the inclination angle θ of the detection plane 53a with respect to the display surface 51a (i.e., the inclination angle θ may not be set to be equal to 0 degrees) when the user is a wheelchair user. The reason for this is that, even when the operation panel 50 is raised, the elbow of a user in a wheelchair may be positioned below the forward extension X of the detection plane 53a.

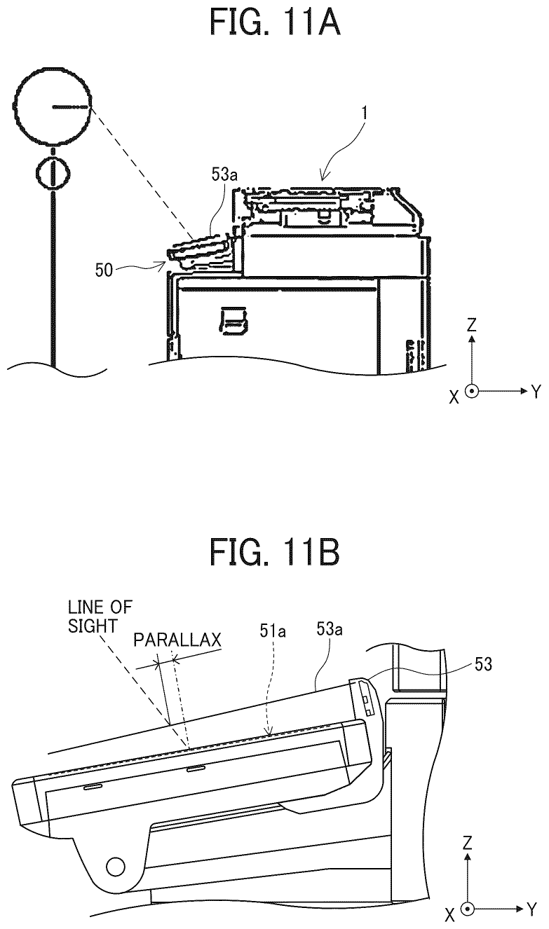

As illustrated in FIGS. 11A and 11B, when the operation panel 50 is in the flat position (or at an angle of 10 degrees to 20 degrees with respect to the horizontal), the angle of the line of sight of the user with respect to the display surface 51a is small. Accordingly, a displacement (i.e., parallax) occurs between a position at which a predetermined position on the operation screen is pointed on the detection plane 53a and a position on the display surface 51a corresponding to the predetermined position on the operation screen. This results in a displacement between a position at which the predetermined position on the operation screen is pointed by the user on the detection plane 53a and the position on the display surface 51a corresponding to the predetermined position on the operation screen, based on the line of sight of the user. In the present embodiment, accordingly, the panel control unit 60 corrects the displacement (i.e., parallax) between the position at which the predetermined position on the operation screen is pointed on the detection plane 53a and the actual predetermined position on the operation screen, based on position information detected by the non-contact sensor 53. In other words, the panel control unit 60 functions as a correction unit.

The input device (e.g., the operation panel 50) further includes circuitry (e.g., the panel control unit 60) configured to change a correction value to correct the position of the object on the detection plane 53a detected by the non-contact detector (e.g., the non-contact sensor 53), based on the detection result of the angle detector (e.g., the operation panel angle detection mechanism 62).

When the operation panel 50 is in the raised position (or at an angle of 45 degrees with respect to the horizontal), the angle of the line of sight of the user with respect to the display surface 51a is large, resulting in small parallax. This leads to a small displacement between the position at which the predetermined position on the operation screen is pointed by the finger of the user on the detection plane 53a and the position on the display surface 51a corresponding to the predetermined position on the operation screen. Accordingly, it is preferable to change the correction value for the position information detected by the non-contact sensor 53, based on the angle of the operation panel 50 detected by the operation panel angle detection mechanism 62.

For example, the ROM 60c of the panel control unit 60 stores a data table in which angles of the operation panel 50 and correction values are associated with each other, and a correction value is identified using the data table and the angle of the operation panel 50 detected by the operation panel angle detection mechanism 62. Then, the position information detected by the non-contact sensor 53 is corrected using the identified correction value. With this configuration, even after the inclination angle of the operation panel 50 is changed, the user can perform the non-contact operation in a natural manner.

Since the angle of the line of sight of the user with respect to the display surface 51a varies depending on the height of the user, the parallax varies. Accordingly, a camera may be used to detect the height of the user standing in front of the operation panel 50, and the correction value for correcting the position information detected by the non-contact sensor 53 may be changed based on the detected height. With this configuration, the user can perform the non-contact operation in a more natural manner.

While a preferred embodiment of the present disclosure has been described above, the present disclosure is not limited to such a specific embodiment unless otherwise specifically limited in the foregoing description, and various modifications and changes can be made without departing from the spirit and scope of the present disclosure as set forth in the appended claims. In the foregoing description, the non-contact sensor 53 serves as a non-contact operation unit and is attachable to the operation panel 50 optionally including the touch panel 52. In another example, an operation panel may include the non-contact sensor 53, but does not include the touch panel 52. An input device according to an embodiment of the present disclosure may be an input device for a bank automated teller machine (ATM), as well as an image forming apparatus.

In some examples, a non-contact operation unit (e.g., the non-contact sensor 53) includes an attachment (e.g., an attachment unit 53d) attachable to an input device (e.g., an operation panel 50) having a display (e.g., a display unit 51) having a display surface 51a on which an operation screen is displayed; a light emitter 53e to emit light in a first direction to form a detection plane 53a above the display surface 51a to detect an object; and a light receiver to receive reflection light, emitted from the light emitter and reflected from the object on the detection plane 53a, to detect a position of the object on the detection plane 53a.

Further, the detection plane is inclined with respect to the display surface. The detection plane has a first distance h1 between a first end (e.g., the user-facing-side edge A2) of the display surface 51a in the first direction (e.g., in the front-rear direction of the image forming apparatus 1) and a first position (e.g., the position A1) on the detection plane, the first position at a position where a perpendicular line perpendicular to the display surface and extending from the first end intersects the detection plane 53a at the first position. The detection plane also has a second distance h2 between a second end (e.g., the rear-side edge B2), opposite to the first end, of the display surface 51a in the first direction and a second position (e.g., the position B1) on the detection plane, the second position at a position where a perpendicular line perpendicular to the display surface and extending from the second end B2 intersects the detection plane 53a at the second position. The first distance h1 is shorter than the second distance h2.

An image forming apparatus incudes an input device including: a display (e.g., a display unit 51) to display an operation screen; and a contact detector (e.g., a touch panel 52) to detect a position of an object performing a contact operation on the operation screen. The non-contact operation unit (e.g., the non-contact sensor 53) is detachably attachable to the image forming apparatus.

The configurations described above are examples, and aspects of the present disclosure provide respective effects as follows.

In Aspect 1, an input device such as an operation panel 50 includes a display unit 51 and a non-contact detector unit such as a non-contact sensor 53. The display unit 51 displays an operation screen and has a display surface 51a. The non-contact detector detects a non-contact operation performed by a pointer or an object, such as a finger of a user, with respect to the operation screen. The non-contact detector unit has a detection plane 53a that detects the non-contact operation performed by the pointer, and the detection plane 53a is inclined with respect to the display surface 51a of the display unit 51 such that a distance from the display surface 51a of the display unit 51 to the detection plane 53a on a first side of the input device is smaller than a distance from the display surface 51a of the display unit 51 to the detection plane 53a on a second side of the input device opposite to the first side, the first side being a user-facing side.

The input device, which is provided in an image forming apparatus, is operated by a user of a general height looking down at the input device. Thus, the input device is attached to the image forming apparatus in such a manner that the display surface 51a of the display unit 51 is in a flat position so as to allow the user to easily view an operation screen displayed on the display surface 51a when the user looks down at the input device.

A user of a general height has an elbow at a position higher than a forward extension X of the detection plane 53a of the non-contact detector such as the non-contact sensor 53 toward the user, and performs a non-contact operation with the user's finger used for operation, which is the pointer, staying perpendicular to (or at a large angle of approach to) the detection plane 53a. As a result, a non-contact operation performed by the finger used for operation, which is the pointer, can be reliably detected.

In contrast, in some cases, a short user has an elbow at a position lower than the forward extension X of the detection plane 53a. In such cases, a non-contact operation is performed with the finger used for operation, which is the pointer, staying non-perpendicular to (or at a small angle of approach to) the detection plane 53a, and a hand portion other than the finger used for operation, such as the fist facing inward, may also enter the detection plane 53a, resulting in erroneous detection of the non-contact operation performed by the user.

In Aspect 1, accordingly, the detection plane 53a is inclined such that a distance from the display surface 51a to the detection plane 53a on the user-facing side is smaller than a distance from the display surface 51a to the detection plane 53a on the rear side facing away from the user. With this configuration, when performing a non-contact operation, a short user can perform the non-contact operation with the user's finger used for operation staying perpendicular to (or at a large angle of approach to) the detection plane 53a, compared to a case where the detection plane 53a is parallel to the display surface 51a. Thus, when a short user performs a non-contact operation, a hand portion other than the finger used for operation can be prevented from entering the detection plane 53a, and erroneous detection of the non-contact operation is less likely to occur.

According to Aspect 2, in the input device of Aspect 1, the detection plane 53a is inclined with respect to the display surface 51a such that, in a case where a user stands in front of the input device, a height h3 of a point on a forward extension X of the detection plane 53a toward the user at a position of an elbow of the user in a front-rear direction of the input device is less than or equal to an elbow height of a 5th-percentile Japanese female.

With this configuration, as described in the embodiment above, for most users, the angle at which the pointer, such as the users' fingers, enters the detection plane 53a can be increased, and a hand portion other than the finger used for operation can be prevented from entering the detection plane 53a. Accordingly, most users can perform non-contact operations reliably.

According to Aspect 3, in the input device of Aspect 1 or Aspect 2, the non-contact detector, such as the non-contact sensor 53, defines an infrared scanning optical path extending along a front-rear direction of the input device such as the operation panel 50, and the non-contact detector receives infrared light reflected from the pointer to detect a position of the pointer on the detection plane 53a, and detects the non-contact operation performed by the pointer.

With this configuration, as described in the embodiment above, the non-contact detector, such as the non-contact sensor 53, is provided on one of the four sides of the display surface 51a, resulting in improved operability without the impairment of appearance compared to a non-contact sensor of the related art that surrounds the four sides of the display surface 51a.

According to Aspect 4, in the input device of Aspect 3, the non-contact detector, such as the non-contact sensor 53, emits the infrared light from the second side of the input device to the first side of the input device, and the non-contact detector includes a light blocking member 54 provided on the first side of the input device relative to the display surface 51a to block the infrared light.

With this configuration, as described in the first modification, the infrared light emitted from the light-emitting elements 53e of the non-contact sensor 53 is blocked by the light blocking member, and therefore a highly reflective object located in front of the input device, such as the operation panel 50, can be prevented from being irradiated with infrared light from the non-contact sensor 53. Thus, it is possible to prevent the light-receiving elements 53f of the non-contact sensor 53 from receiving infrared light reflected from the highly reflective object and to prevent erroneous detection of a non-contact operation.

According to Aspect 5, in the input device of any one of Aspects 1 to 4, a distance from the display surface 51a to the detection plane 53a is greater than or equal to 10 mm and less than or equal to 15 mm.

With this configuration, as described in the embodiment above, the user can perform a non-contact operation without coming into contact with the display surface 51a, and can perform the non-contact operation reliably even when viewing the operation screen displayed on the display surface 51a of the display unit 51 from a slightly different angle.

According to Aspect 6, in the input device of any one of Aspects 1 to 5, the display surface 51a has a first edge (user-facing-side edge A2) on the first side of the input device, and a second edge (rear-side edge B2) on the second side of the input device, and a difference between a dimension L1 of the detection plane 53a measured from a position A1 at which a perpendicular line extending from the first edge (user-facing-side edge A2) of the display surface 51a intersects the detection plane 53a to a position B1 at which a perpendicular line extending from the second edge (rear-side edge B2) of the display surface 51a intersects the detection plane 53a and a dimension L2 of the display surface 51a measured from the first edge (user-facing-side edge A2) to the second edge (rear-side edge B2) is less than or equal to 0.5 mm.

With this configuration, as described in the embodiment above, the user can perform the non-contact operation in a natural manner.

According to Aspect 7, in the input device of any one of Aspects 1 to 6, the detection plane 53a has an adjustable inclination angle with respect to the display surface 51a.

With this configuration, as described in the second modification, when the inclination angle of the display surface 51a with respect to the horizontal is large or when the user is tall, a hand portion other than the pointer such as the finger does not enter the detection plane 53a, and a non-contact operation can be reliably detected even if the detection plane 53a is set to be parallel to the display surface 51a. Accordingly, when the inclination angle of the display surface 51a with respect to the horizontal is large or when the user is tall, the inclination angle of the detection plane 53a with respect to the display surface 51a can be adjusted such that the detection plane 53a is parallel to the display surface 51a. Setting the detection plane 53a to be parallel to the display surface 51a eliminates the difference in distance from the display surface 51a between when the user performs a non-contact operation on the user-facing side and when the user performs a non-contact operation on the rear side facing away from the user, and allows the user to perform the non-contact operation in a natural manner. In contrast, when the inclination angle of the display surface 51a with respect to the horizontal is small or when the user is short, the inclination angle of the detection plane 53a with respect to the display surface 51a is adjusted to increase, thereby preventing a hand portion other than the pointer such as the finger from entering the detection plane 53a and making it less likely that erroneous detection of a non-contact operation will occur.

According to Aspect 8, in the input device of Aspect 7, an angle of the display surface 51a with respect to a horizontal is changeable, and the input device further includes an angle detector such as an operation panel angle detection mechanism 62 and an adjuster such as a sensor drive unit 63. The angle detection mechanism detects the angle of the display surface 51a with respect to the horizontal. The adjuster adjusts the inclination angle of the detection plane 53a with respect to the display surface 51a, based on a detection result of the angle detection mechanism.

With this configuration, as described in the second modification, the inclination angle of the detection plane 53a with respect to the display surface 51a can be automatically adjusted based on a change in the angle of the display surface 51a with respect to the horizontal.

According to Aspect 9, the input device of Aspect 8 further includes a correction unit such as a panel control unit 60. The correction unit corrects a position of the pointer, such as the finger used for operation, on the detection plane 53a detected by the non-contact detector such as the non-contact sensor 53. The correction unit changes a correction value for correcting the position of the pointer, based on the detection result of the angle detection mechanism such as the operation panel angle detection mechanism 62.

With this configuration, as described in the second modification, the position of the pointer detected by the non-contact detector, such as the non-contact sensor 53, can be corrected in accordance with a displacement (parallax) between a position at which a predetermined position on the operation screen is pointed on the detection plane 53a and a position on the display surface 51a corresponding to the predetermined position on the operation screen on the display surface 51a, due to the angle of the display surface 51a with respect to the horizontal. The user can perform a non-contact operation in a natural manner regardless of whether the display surface 51a is in a flat position or a raised position.

According to Aspect 10, the input device of any one of Aspects 1 to 9 further includes a contact detector such as a touch panel 52. The contact detector detects a contact operation performed by the pointer on the operation screen.

With this configuration, both a non-contact operation and a contact operation can be performed.

In Aspect 11, a non-contact operation unit such as a non-contact sensor 53 for detecting a non-contact operation performed by a pointer or an object with respect to an operation screen, the non-contact operation unit being attachable to and detachable from an input device such as an operation panel 50, the input device including a display unit 51 that displays the operation screen and has a display surface 51a, and a contact detector such as a touch panel 52 that detects a contact operation performed by the pointer on the operation screen includes a detection plane 53a. The detection plane 53a detects the non-contact operation performed by the pointer. The detection plane 53a is inclined with respect to the display surface 51a of the display unit 51 such that a distance from the display surface 51a of the display unit 51 to the detection plane 53a on a first side of the input device is smaller than a distance from the display surface 51a of the display unit 51 to the detection plane 53a on a second side of the input device opposite to the first side, the first side being a user-facing side.

With this configuration, as in Aspect 1, when a short user performs a non-contact operation, a hand portion other than the finger used for operation can be prevented from entering the detection plane 53a, and erroneous detection of the non-contact operation is less likely to occur.

According to Aspect 12, an image forming apparatus 1 includes an input device such as an operation panel 50. The input device includes the input device of any one of Aspects 1 to 10.

With this configuration, when a short user performs a non-contact operation, a hand portion other than the finger used for operation can be prevented from entering the detection plane 53a, and erroneous detection of the non-contact operation is less likely to occur.

In Aspect 13, an image forming apparatus includes an input device such as an operation panel 50. The input device includes a display unit 51 and a contact detector such as a touch panel 52. The display unit 51 displays an operation screen. The contact detector detects a contact operation performed by a pointer on the operation screen. The non-contact operation unit of Aspect 11 is attachable to the image forming apparatus 1.

With this configuration, a non-contact operation can be performed as an option.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An input device comprising:
a display having a display surface on which an operation screen is displayed; and
a non-contact detector including:
a light emitter to emit light in a first direction to form a detection plane above the display surface to detect an object; and
a light receiver to receive reflection light, emitted from the light emitter and reflected from the object on the detection plane, to detect a position of the object on the detection plane,
wherein the detection plane is inclined with respect to the display surface, and
the detection plane has:
a first distance between:
a first end of the display surface in the first direction; and
a first position on the detection plane, the first position at a position where a perpendicular line perpendicular to the display surface and extending from the first end intersects the detection plane at the first position; and
a second distance between:
a second end, opposite to the first end, of the display surface in the first direction; and
a second position on the detection plane, the second position at a position where a perpendicular line perpendicular to the display surface and extending from the second end intersects the detection plane at the second position, and
the first distance is shorter than the second distance.

2. The input device according to claim 1, wherein the detection plane has an inclination angle of three degrees to five degrees with respect to the display surface.

3. The input device according to claim 1, further comprising circuitry configured to:
receive the position of the object from the non-contact detector; and
detect a non-contact operation performed by the object without contacting the display surface,
wherein the light emitter emits infrared light having a scanning optical path in the first direction.

4. The input device according to claim 3, further comprising:
a light shield, at a third end downstream from the first end in the first direction, to block the infrared light.

5. The input device according to claim 1,
wherein each of the first distance and the second distance is:
greater than or equal to 10 mm; and
less than or equal to 15 mm.

6. The input device according to claim 1, wherein
a difference between a first dimension and a second dimension is less than or equal to 0.5 mm, and
the first dimension is a dimension of the detection plane from the first position to the second position, and
the second dimension is a dimension of the display surface from the first end to the second end.

7. The input device according to claim 1, wherein the detection plane has an adjustable inclination angle with respect to the display surface.

8. The input device according to claim 7, further comprising:
an angle detector to detect a changeable angle of the display surface with respect to a horizontal direction of the display surface; and
an adjuster to adjust the adjustable inclination angle of the detection plane with respect to the display surface, based on a detection result of the angle detector.

9. The input device according to claim 8, further comprising circuitry configured to change a correction value to correct the position of the object on the detection plane detected by the non-contact detector, based on the detection result of the angle detector.

10. The input device according to claim 1, further comprising a contact detector to detect a position of the object performing a contact operation on the operation screen.

11. A non-contact operation unit comprising:
an attachment attachable to an input device having a display having a display surface on which an operation screen is displayed;
a light emitter to emit light in a first direction to form a detection plane above the display surface to detect an object; and
a light receiver to receive reflection light, emitted from the light emitter and reflected from the object on the detection plane, to detect a position of the object on the detection plane,
wherein the detection plane is inclined with respect to the display surface, and
the detection plane has:
a first distance between:
a first end of the display surface in the first direction; and
a first position on the detection plane, the first position at a position where a perpendicular line perpendicular to the display surface and extending from the first end intersects the detection plane at the first position; and
a second distance between:
a second end, opposite to the first end, of the display surface in the first direction; and
a second position on the detection plane, the second position at a position where a perpendicular line perpendicular to the display surface and extending from the second end intersects the detection plane at the second position, and
the first distance is shorter than the second distance.

12. An image forming apparatus comprising the input device according to claim 1.

13. An image forming apparatus comprising an input device including:
a display to display an operation screen; and
a contact detector to detect a position of an object performing a contact operation on the operation screen, wherein
the non-contact operation unit according to claim 11 is detachably attachable to the image forming apparatus.
